(19) United States
(12) Patent Application Publication
(10) Pub. No.: US 2004/0260014 A1
(43) Pub. Date: Dec. 23, 2004

(54) Blocked polyisocyanates

(76) Inventors: Thomas Munzmay, Dormagen (DE); Jan Mazanek, Koln (DE); Jurgen Meixner, Krefeld (DE); Joachim Petzoldt, Monheim (DE); Heino Muller, Leverkusen (DE)

Correspondence Address: BAYER MATERIAL SCIENCE LLC, 100 BAYER ROAD, PITTSBURGH, PA, 15205, US

(21) Appl. No.: 10/869,110

(22) Filed: Jun. 16, 2004

(30) Foreign Application Priority Data
Jun. 23, 2003 (DE) 10328064.2

(51) Int. Cl. C08K 3/00

(52) U.S. Cl. 524/589

(57) ABSTRACT

The invention concerns aqueous preparations of water-dilutable blocked polyisocyanates, their production and use in optionally self-crosslinking one-component systems. The blocked polyisocyanates have a structure according to formula (I)

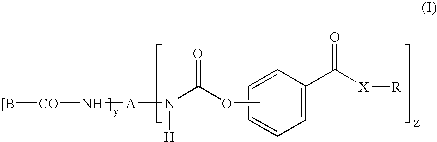

where

A denotes a radical of a polyisocyanate,

B denotes a radical of a cationic, anionic and/or non-ionic hydrophilising agent,

X denotes oxygen, NH or NR,

R denotes hydrogen, C₁ to C₈ alkyl or cycloalkyl,

Z stands for the number 1 to 8, and

Y denotes a number from 0.1 to 4.0, the equivalent ratio of z to y being from 20:1 to 1:1.

### CROSS REFERENCE TO RELATED PATENT APPLICATION

The present patent application claims the right of priority under 35 U.S.C. §119 (a)-(d) of German Patent Application No. 103 28 064.2, filed Jun. 23, 2003.

### FIELD OF THE INVENTION

The invention concerns aqueous and/or water-dilutable blocked polyisocyanates, their production and use in optionally self-crosslinking one-component systems.

### BACKGROUND OF THE INVENTION

The use of blocking agents for the temporary protection of isocyanate groups has long been known. Blocked polyisocyanates are used to produce heat-curable one-component PUR stoving systems that are stable in storage at room temperature. Here the blocked polyisocyanates are mixed with e.g. hydroxyl group-containing polyesters, polyacrylates, other polymers and other components of lacquers and paints such as pigments, cosolvents or additives. Another possibility for obtaining stoving enamels that are stable in storage at room temperature is the partial blocking of the isocyanate groups in polymers containing both blocked isocyanates and hydroxyl groups.

The most important compounds that are used to block polyisocyanates are ε-caprolactam, methyl ethyl ketoxime, malonic acid esters, secondary amines, optionally substituted phenols and triazole and pyrazole derivatives, such as are described for example in EP-A 0 576 952, EP-A 0 566 953, EP-A 0 159 117, U.S. Pat. No. 4,482,721, WO 97/12924 or EP-A 0 744 423.

The use of carboxylic acid derivatives containing aromatic hydroxyl groups is also known per se. Thus U.S. Pat. No. 6,288,199 describes the use of polyisocyanates that are at least partially blocked with mixtures of aromatic hydroxyl compounds and hydroxybenzoic acid esters.

EP-A 0 539 802 describes the use of crosslinking agents consisting of polyisocyanates and 4-hydroxybenzoic acid ethyl ester in the production of adhesive resins. These are non-aqueous dispersions for the production of free-flowing thermoplastic, powdered polyurethanes, which likewise contain reaction products of polyisocyanates with 4-hydroxybenzoic acid ethyl ester as crosslinking agent.

The use of isophorone diisocyanate blocked with 4-hydroxybenzoic acid esters for powder coatings is described in JP-A 550 031 415, as is the use of 4-hydroxybenzoate (JP-A 04 144 787) as a blocking agent for polyisocyanates for the production of heat-activated negative materials.

The use of hydroxybenzoic acid esters as blocking agents for aqueous systems has not previously been known. All blocking agents cited in the aforementioned patent specifications exhibit specific disadvantages. Firstly, blocking agents are claimed that cannot be used in all processes because of their high activation temperature. Secondly, blocking agents having a very low separation temperature are cited, such as e.g. malonic acid dialkyl esters, which because of their high reactivity display only a limited storage stability in water, however. The best blocking agents in terms of storage stability in the aqueous preparation and of reactivity, butanone oxime and diisopropylamine, require additional health and safety outlay because of their classification as dangerous substances, which inevitably leads to higher costs for the end users of these products.

There was thus an urgent need for products that avoid the aforementioned disadvantages and problems of known systems.

The object of the present invention was therefore to find water-stable dispersions of blocked polyisocyanates that display high environmental compatibility when used in lacquers, paints and other coating compositions.

### SUMMARY OF THE INVENTION

The present invention provides aqueous preparations that include blocked polyisocyanates according to formula (I)

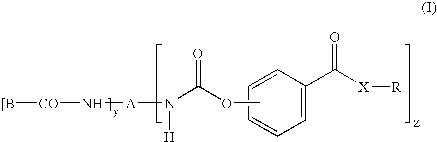

where

A denotes a radical of a polyisocyanate

B denotes a radical of a cationic, anionic and/or non-ionic hydrophilising agent,

X denotes oxygen, NH or NR,

R denotes hydrogen, C₁ to C₈ alkyl or cycloalkyl

Z stands for the number 1 to 8 and

Y denotes a number from 0.1 to 4.0, the equivalent ratio of z to y being from 20:1 to 1:1.

The present invention provides for preparations as described above including blocked isocyanates prepared by reacting

a) 100% equivalent % polyisocyanate

b) 40-90 equivalent % hydroxybenzoic acid (derivative)

c) 10-40 equivalent % of a hydrophilising agent and optionally

d) 0-40 equivalent % of a preferably difunctional compound containing hydroxyl and/or amino groups and having an average molecular weight of 62 to 3000

wherein the proportions of the reaction components are chosen such that the equivalent ratio of NCO groups in component a) to isocyanate-reactive groups in component b), c) and d) is from 1:0.8 to 1:1.2.

The present invention is also directed to a process for the production of the above-described preparations including reacting polyisocyanates with hydroxycarboxylic acids or derivatives thereof according to formula II

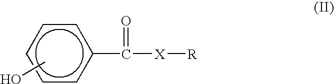

where

X denotes oxygen, NH or NR,

R denotes hydrogen, a C₁ to C₈ alkyl or cylcoalkyl radical,

optionally in the presence of catalysts and/or cosolvents, optionally in water-miscible or in water-immiscible solvents, and

dissolving or dispersing the mixtures thus obtained in water or diluted with water-miscible solvents to form water-miscible solutions.

The present invention further provides a method of preparing lacquers, paints and other coating materials, adhesives or elastomers by combining the above-described preparations with one or more materials selected from polyols, pigments, fillers, flow control agents, defoaming agents, catalysts and combinations thereof.

The present invention additionally provides a method of coating a substrate by applying the stoving system described above to a surface of the substrate, where the substrate is selected from wood, metals, textiles, mineral substances and plastics and composites.

Also provided in the present invention is a process for coating substrates by applying coating formulations that include the above described aqueous preparations to a substrate and then heating the substrate to a temperature at which the p-hydroxybenzoic acid ester is eliminated and the isocyanate groups are thereby released to react with the crosslinking agent to form a crosslinked polyurethane.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

The object of the invention was achieved with the preparations of blocked polyisocyanates according to the invention and with self-crosslinking one-component stoving systems containing them.

The present invention provides aqueous preparations of blocked polyisocyanates having the formula (I)

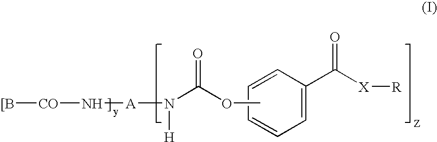

wherein

A denotes the radical of a polyisocyanate

B denotes the radical of a cationic, anionic and/or non-ionic hydrophilising agent,

X denotes oxygen, NH or NR,

R denotes hydrogen, C₁ to C₈ alkyl or cycloalkyl

Z stands for the number 1 to 8, preferably 2 to 6, particularly preferably 2.5 to 4.0, and

Y denotes a number from 0.1 to 4.0, preferably 0.2 to 2.0, the equivalent ratio of z to y being 20:1 to 1:1, preferably 10:1 to 2:1, particularly preferably 8:1 to 4:1,

and self-crosslinking one-component stoving systems based thereon.

The blocked polyisocyanates having the general formula (I) used in the preparations according to the invention can be obtained by reacting polyisocyanates with hydroxycarboxylic acids or derivatives thereof having the formula (II)

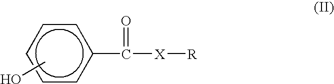

wherein

X denotes oxygen, NH or NR,

R denotes hydrogen, a C₁ to C₈ alkyl or cylcoalkyl radical.

Methyl, ethyl and propyl esters of o- and/or p-hydroxybenzoic acid are particularly preferred.

The invention also provides the use of the preparations according to the invention of blocked polyisocyanates for the production of lacquers, paints and other coating materials, adhesives and elastomers and the coating of substrates with these preparations.

Examples of the hydroxybenzoic acids according to the invention or derivatives thereof that can be cited are: o-, m- and p-hydroxybenzoic acid and methyl, ethyl, (iso)propyl, butyl, 2-ethylhexyl, tert.-butyl neopentyl esters thereof, amides such as methylamide and ethylamide, dimethylamide and diethylamide.

Suitable polyisocyanates for the production of the blocked polyisocyanates contained in the preparations according to the invention are all hydrophilised, aliphatic, cycloaliphatic and aromatic polyisocyanates known per se having an isocyanate content of 0.5 to 50, preferably 3 to 30, particularly preferably 5 to 25 wt. %, such as tetramethylene diisocyanate, cyclohexane-1,3- and -1,4-diisocyanate, hexamethylene diisocyanate (HDI), 1-isocyanato-3,3,5-trimethyl-5-isocyanatomethyl cyclohexane (isophorone diisocyanate, IPDI), methylene bis-(4-isocyanatocyclohexane), tetramethyl xylylene diisocyanate (TMXDI), triisocyanatononane.

Also suitable are aromatic polyisocyanates such as toluylene diisocyanate (TDI), diphenylmethane-2,4′- and/or -4,4′-diisocyanate (MDI), triphenylmethane-4,4′-diisocyanate, naphthylene-1,5-diisocyanate.

Preferably suitable are polyisocyanates that contain heteroatoms in the radical containing the isocyanate groups. Examples thereof are polyisocyanates displaying carbodiimide groups, allophanate groups, isocyanurate groups, urethane groups and biuret groups.

Particularly preferably suitable for the invention are the known polyisocyanates that are primarily used for the production of lacquers, e.g. modification products of the aforementioned simple polyisocyanates displaying biuret, isocyanurate or uretdione groups, of hexamethylene diiosocyanate or isophorone diisocyanate in particular.

Also suitable are low-molecular polyisocyanates containing urethane groups, such as can be obtained by reacting IPDI or TDI used in excess with simple polyhydric alcohols in the molecular weight range 62-300, in particular with trimethylol propane or glycerol.

Suitable polyisocyanates are also the known prepolymers displaying terminal isocyanate groups, such as are obtainable in particular by reacting the aforementioned simple polyisocyanates, above all diisocyanates, with smaller amounts of organic compounds having at least two isocyanate-reactive functional groups. In these known prepolymers the ratio of isocyanate groups to NCO-reactive hydrogen atoms corresponds to 1.05:1 to 10:1, preferably 1.1:1 to 3:1, the hydrogen atoms preferably deriving from hydroxyl groups. The type and proportions of the starting materials used in the production of NCO prepolymers are incidentally preferably chosen such that the NCO prepolymers preferably display an average NCO functionality of 2 to 3 and a number-average molecular weight of 500 to 10,000, preferably 800 to 4000.

Also suitable as polyisocyanates within the meaning of the invention are such polymers containing free isocyanate groups and based on polyurethane, polyester and/or polyacrylate and optionally mixtures thereof, in which only part of the free isocyanate groups is reacted with the blocking agents according to the invention, whilst the remaining part is reacted with an excess of hydroxyl group-containing polyesters, polyurethanes and/or polyacrylates and optionally mixtures thereof, such that a polymer containing free hydroxyl groups is formed that on heating at suitable stoving temperatures crosslinks without addition of other isocyanate group-reactive groups (self-crosslinking one-component stoving systems).

Naturally all cited polyisocyanates can also be used as mixtures with one another or with other crosslinking agents such as with melamine resins to produce lacquers, paints and other formulations.

Production of the blocked polyisocyanates according to the invention can be performed using methods known per se. For example, one or more polyisocyanates can be prepared and the blocking agent added with stirring (within around 10 minutes, for example). Stirring is continued until no more free isocyanate can be detected. It is also possible to block one or more polyisocyanates with a mixture of two or more blocking agents (optionally also not according to the invention). Production in optionally water-miscible solvents is also possible of course. However it is also possible to produce the polyisocyanates according to the invention in water-immiscible solvents and then to disperse these mixtures in water or to dilute them with water-miscible solvents such as acetone or N-methyl pyrrolidone to produce water-miscible solutions. Catalysts, cosolvents and other auxiliary substances and additives can also be used in the production of the polyisocyanates according to the invention.

A substantial component of the production of the blocked polyisocyanates according to the invention is their hydrophilisation, which causes the polyisocyanates produced in this way to remain in solution after addition of water or alternatively to form fine-particle, sedimentation-stable dispersions. All cationic, anionic and/or non-ionic compounds that are suitable for this purpose can be used as hydrophilising agents to this end, such as monohydroxycarboxylic and/or dihydroxycarboxylic acids or monofunctional alkyl ethoxylates. Mixtures of various hydrophilising agents can naturally also be used.

The hydrophilising agents can be incorporated into the polyisocyanates according to the invention by methods known per se. For example, part of the isocyanate groups can be reacted with the blocking agents according to the invention first and then the rest reacted with the hydrophilising agent. The process can also be performed in the reverse sequence, however, or blocking of the isocyanate groups can be performed in two steps, namely before and after hydrophilisation.

Naturally the hydrophilising agents can also be added at a different stage of production of the polyisocyanates according to the invention, such as during production of the prepolymers for example. Hydrophilised polyethers, polyesters and/or polyacrylates can moreover also be used as hydrophilising agents, such as are used in the production of self-crosslinking one-component stoving enamels, for example.

If monohydroxycarboxylic or dihydroxycarboxylic acids are used for hydrophilisation, this is followed by a full or partial neutralisation of the carboxyl groups. Neutralisation can be performed with any amines such as triethylamine, dimethyl cyclohexylamine, methyl diisopropylamine or dimethyl ethanolamine. Ammonia is also suitable.

As crosslinking agents the blocked polyisocyanates according to the invention as hydrophilised aqueous and/or water-dilutable blocked polyisocyanates have the following composition, for example:

a) 100 equivalent % polyisocyanate

b) 40 to 90, preferably 60 to 85 equivalent % hydroxybenzoic acid derivatives having formula (II)

c) 10 to 40, preferably 10 to 25 equivalent % of a hydrophilising agent and optionally

d) 0 to 40, preferably 5 to 25 equivalent % of a preferably difunctional compound containing hydroxyl and/or amino groups and having an average molecular weight of 62 to 3000, preferably 62 to 1500, the proportions of the reaction partners being chosen such that the equivalent ratio of NCO groups in component a) to isocyanate-reactive groups in components b), c) and d) is 1:0.8 to 1:1.2, and optionally additives and auxiliary substances.

Diamines, diols and also hydroxylamines in the molecular weight range from 32 to 300 are suitable as the difunctional chain extension component c). Examples are hydrazine, ethylene diamine, isophorone diamine, the bis-ketimine obtained from isophorone diamine and methyl isobutyl ketone, 1,4-dihydroxybutane, ethanolamine, N-methyl ethanolamine, hydroxyethyl ethylene diamine, the adduct of 2 moles of propylene carbonate and 1 mole of hydrazine having formula (III).

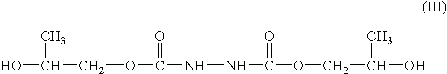

The aqueous and/or water-dilutable blocked polyisocyanates take the form of either solutions in preferably water-miscible solvents such as N-methyl pyrrolidone with a concentration of 40 to 95, preferably 60 to 85 wt. %, or of fine-particle dispersions with a solids content of 25 to 70, preferably 35 to 50 wt. %.

As described above, the polyisocyanates according to the invention are either self-crosslinking polymers or crosslinking agents for any polyol components. Examples of polyol components, which can also be used as mixtures, are:

polyhydroxypolyesters, polyhydroxypolyethers or polymers and polycarbonates displaying hydroxyl groups, e.g. the polyhydroxypolyacrylates known per se. The compounds generally display a hydroxyl value from 20 to 200, preferably 50 to 130, relative to 100% products.

The polyhydroxypolyacrylates are known copolymers and copolycarbonates of styrene with simple esters of acrylic acid and/or methacrylic acid, hydroxyalkyl esters such as e.g. 2-hydroxyethyl, 2-hydroxypropyl, 2-, 3- or 4-hydroxybutyl esters of these acids being incorporated in order to introduce the hydroxyl groups.

Suitable polyester polyols are in particular linear polyester diols or weakly branched polyester polyols, such as can be produced by known means from aliphatic, cycloaliphatic or aromatic dicarboxylic or polycarboxylic acids or anhydrides thereof, such as e.g. succinic, glutaric, adipic, pimelic, suberic, azelaic, sebacic, nonane dicarboxylic, decane dicarboxylic, terephthalic, tetrahydrophthalic, isophthalic, o-phthalic, hexahydrophthalic or trimellitic acid and acid anhydrides, such as o-phthalic, trimellitic or succinic anhydride or mixtures thereof with polyhydric alcohols, such as e.g. ethanediol, diethylene, triethylene, tetraethylene glycol, 1,2-propanediol, dipropylene, tripropylene, tetrapropylene glycol, 1,3-propanediol, butanediol-1,4, butanediol-1,3, butanediol-2,3, pentanediol-1,5, hexanediol-1,6, 2,2-dimethyl-1,3-propanediol, 1,4-dihydroxycyclohexane, 1,4-dimethylol cyclohexane, octanediol-1,8, decanediol-1,10, dodecanediol-1,12 or mixtures thereof, optionally with the incorporation of higher-functional polyols, such as trimethylol propane or glycerol.

Also suitable of course as polyhydric alcohols for the production of polyester polyols are cycloaliphatic and/or aromatic dihydroxyl and polyhydroxyl compounds. In place of the free polycarboxylic acid the corresponding polycarboxylic anhydrides or corresponding polycarboxylic acid esters of low alcohols or mixtures thereof can also be used to produce the polyesters.

The polyester polyols can naturally also be homopolymers or copolymers of lactones, which are preferably obtained by addition of lactones or lactone mixtures, such as butyrolactone, ε-caprolactone and/or methyl ε-caprolactone, to suitable difunctional and/or higher-functional starter molecules, such as e.g. the low-molecular, polyhydric alcohols cited above as structural components for polyester polyols.

Also suitable as polyhydroxyl components are polycarbonates displaying hydroxyl groups, e.g. those that can be produced by reacting diols such as 1,4-butanediol and/or 1,6-hexanediol with diaryl carbonates, e.g. diphenyl carbonate, dialkyl carbonate, such as dimethyl carbonate or phosgene, preferably having a molecular weight of 800 to 5000.

Suitable as polyether polyols are e.g. the polyaddition products of styrene oxides, of ethylene oxide, propylene oxide, tetrahydrofuran, butylene oxide, and their coaddition products and graft products, together with the polyether polyols obtained by condensation of polyhydric alcohols or mixtures thereof and by alkoxylation of polyhydric alcohols, amines and amino alcohols.

Particularly preferred structural components are the homopolymers, copolymers and graft polymers of propylene oxide and ethylene oxide, which are obtainable by addition of the cited epoxides to low-molecular diols or triols, such as were cited above as structural components for polyester polyols, or to water.

Other particularly preferred structural components are polyester diols based on adipic acid and glycols such as 1,4-butanediol, 1,6-hexanediol and/or 2,2-dimethyl-1,3-propanediol (neopentyl glycol). Likewise particularly preferred are copolymers of 1,6-hexanediol with ε-caprolactone and diphenyl carbonate having a molecular weight of 1000 to 4000, and 1,6-hexanediol polycarbonate diols having a molecular weight of 1000 to 3000.

The polyester polyols are produced by known methods as described for example in Houben-Weyl, Methoden der organischen Chemie, Volume XIV/2, G. Thieme-Verlag, 1963, pages 1 to 47. Hydrophilic modification of these polyhydroxyl compounds, which may optionally be necessary, is performed by methods known per se, as disclosed for example in EP-A-0 157 291 or EP-A-0 427 028.

Structural components that can optionally be incorporated are diols and polyols in the molecular weight range from 62 to 299. Suitable examples include the polyhydric, particularly dihydric alcohols cited for the production of the polyester polyols and also low-molecular polyester diols, such as e.g. adipic acid bis(hydroxyethyl)ester or short-chain homoaddition and coaddition products of ethylene oxide or propylene oxide started on aromatic diols. Preferred structural components that can optionally be incorporated are 1,2-ethanediol, 1,4-butanediol, 1,6-hexanediol and 2,2-dimethyl propanediol-1,3. 1,4-butanediol and 1,6-hexanediol are particularly preferred.

Other suitable structural components ii) are triols such as glycerol, trimethylol propane, trimethylol ethane and alkoxylation products thereof.

Mixtures or reaction products based on polyesters, polyethers and polyacrylates, optionally also modified with known polyurethanes, can naturally also be used.

The blocked polyisocyanates according to the invention are used for the production of stoving enamels, for the coating of substrates, preferably consisting of metals, mineral substances, wood, plastics, e.g. for industrial lacquering, in textile coating and in automotive primary finishing. To this end the coating compositions according to the invention can be applied by knife application, dipping, spraying, such as compressed air or airless spraying, and by electrostatic application, for example high-speed bell application. The dry film thickness can be 10 to 120 μm, for example. The dried film is cured by stoving in the temperature range from 90 to 160° C., preferably 110 to 140° C., particularly preferably 120 to 130° C.

Lacquers, paints and other formulations are produced from the polyisocyanates according to the invention by methods known per se. In addition to the polyisocyanates and polyols, conventional additives and other auxiliary substances (e.g. pigments, fillers, flow control agents, defoaming agents, catalysts) can be added to the formulations in quantities that can easily be determined by the person skilled in the art.

The examples below illustrate the invention in more detail without restricting it.

### EXAMPLES

Particle sizes were determined by laser correlation spectroscopy (LCS).

### Example 1

(Production of an Aqueous Dispersion According to the Invention)

9.45 g (0.08 mol) 1,6-hexanediol were added at room temperature with stirring to 343.20 g (1.76 val) of a commercial isocyanurate-containing lacquer polyisocyanate based on 1,6-diisocyanatohexane (HDI) and having an NCO content of 21.4 wt. %, a viscosity at 23° C. of 3000 mPas and a functionality of 3.5. After heating to 70° C. stirring was continued for 2 hours until an NCO value of 19.05% (theoretically 19.06%) was reached. 16 g Pluriol® (0.032 mol) (BASF AG, Ludwigshafen), 154.22 g (0.928 mol) 4-hydroxybenzoic acid ethyl ester and 2.61 g Dabco (Air Products) were then added and stirred for a further 2 hours until an NCO value of 4.0% was reached. 47.20 g (0.940 mol) hydroxypivalic acid, dissolved in 10.36 g N-methylpyrrolidone, were then added. Stirring was continued at 70° C. until no more NCO groups could be detected by IR spectroscopy (4 hours). 39.22 g (0.44 mol) dimethyl ethanolamine were then added at 70° C. and stirring was continued for 15 minutes. 1351 g deionised water at a temperature of 70° C. were then added and the mixture was dispersed for 1 hour at 70° C. After cooling to room temperature a stable white dispersion with the following properties was formed:

| | |
|---|---|
| Solids content: | 30% |
| pH: | 8.02 |
| Viscosity (23° C.): | 2000 mPas |
| Average particle size (LCS): | 57 nm |

### Example 2

(Production of a Polyisocyanate Crosslinking Agent According to the Invention)

343.20 g (1.76 val) of a commercial isocyanurate-containing lacquer polyisocyanate based on 1,6-diisocyanatohexane (HDI) and having an NCO content of 21.4 wt. %, a viscosity at 23° C. of 3000 mPas and a functionality of 3.5 were heated to 70° C. with stirring and 9.45 g (0.08 mol) 1,6-hexanediol were added within 10 minutes. Following addition of a solution of 37.76 g (0.32 val) hydroxypivalic acid in 60.93 g N-methylpyrrolidone (within 10 minutes), stirring was continued for 4 hours at 70° C. The NCO content of the reaction mixture was then 11.02%. 196.80 g (1.184 mol) 4-hydroxybenzoic acid ethyl ester and 5.33 g Dabco (Air Products) were then added at 70° C. and stirring was continued for 2 hours. No more NCO could then be found by IR spectroscopy. 31.38 g (0.352 mol) dimethyl ethanolamine were added at 70° C. within 10 minutes, stirring was continued for 10 minutes and ¹³⁵¹ g deionised water at a temperature of 70° C. were then added with stirring and stirring was continued for 1 hour at 70° C. After cooling to room temperature with stirring, a dispersion with the following properties was obtained:

| | |
|---|---|
| Solids content: | 30% |
| pH: | 8.31 |
| Viscosity: | 2300 mPas |
| Particle size (LCS): | 62 nm |

### Example 3

(Production of a Water-Dilutable Polyisocyanate Crosslinking Agent)

58.80 g (0.297 val) of a commercial isocyanurate-containing lacquer polyisocyanate based on 1,6-diisocyanatohexane (HDI) and having an NCO content of 21.4 wt. %, a viscosity at 23° C. of 3000 mPas and a functionality of 3.5, 7.08 g (0.06 mol) hydroxypivalic acid and 56.57 g N-methylpyrrolidone were mixed together with stirring and heated to 70° C. within 30 minutes. Stirring was continued for 2 hours at this temperature and the temperature then increased to 80° C. After a further 2 hours an NCO content of 7.60% was reached, the reaction mixture was cooled to 70° C. and 36.89 g (0.222 mol) 4-hydroxybenzoic acid ethyl ester and 1.0 g Dabco (Air Products) were then added within 15 minutes and stirred for a further 2 hours. The completeness of the reaction was detected by IR spectrum. 5.35 g (0.06 mol) dimethyl ethanolamine were then added at 60° C. and stirred for 10 minutes. A clear solution of the blocked polyisocyanate was obtained with a solids content of 68% and with a content of blocked NCO groups of 5.69%.

### Example 4

### Comparative Example I

Example 1 was repeated, except that butanone oxime was used in place of 4-hydroxybenzoic acid ethyl ester/Dabco. The dispersion obtained had the following properties:

| | |
|---|---|
| Solids content: | 38% |
| pH: | 8.5 |
| Viscosity (23° C.): | 4000 mPas |
| Particle size (LCS): | 42 nm |

### Example 5

(Production of a Self-Crosslinking One-Component Stoving System)

53.66 g (0.4 mol) dimethylol propionic acid, dissolved in 106.80 g N-methyl pyrrolidone, were added at 85° C. with stirring to a mixture comprising 337.5 g (3.035 val) isophorone diisocyanate, 18.02 g (0.2 mol) 1,4-butanediol, 13,42 g (0.1 mol) trimethylol propane, 22.5 g (0.045 mol) methanol ethoxylate having an average molecular weight of 500 and 205.80 g (0.49 val) of a polyester consisting of adipic acid and hexanediol having an average molecular weight of 840, and the reaction mixture was stirred for 4 hours at this temperature. The NCO content was then 4.78% (theoretically 4.80%). 101.37 g (0.61 val) 4-hydroxybenzoic acid ethyl ester and 3.76 g Dabco (Air Products) were added within 20 minutes. The reaction mixture was stirred for 110 minutes at 100° C. until an NCO content of 1.85% (theoretically 1.90%) was reached. 318.8 g (1 val) of a polyester consisting of adipic acid, isophthalic acid, trimethylol propane, neopentyl glycol and propylene glycol were then added and the reaction mixture stirred for 10 hours at 85° C. No more NCO groups could then be detected by R spectroscopy. 35.57 g (0.4 mol) dimethyl ethanolamine were then added and stirred for 10 minutes. Following addition of 2015 g deionised water at a temperature of 70° C., the mixture was dispersed for 1 hour at 70° C. The white dispersion obtained had the following properties:

| | |
|---|---|
| Solids content: | 35% |
| pH: | 8.5 |
| Viscosity (23° C.): | 70 mPas |
| Particle size (LCS): | 32 nm |

### Example 6

### Comparative Example II

Example 4 was repeated, except that butanone oxime was used in place of the blocking agent according to the invention. The dispersion obtained had the following properties:

| | |
|---|---|
| Solids content: | 40% |
| pH: | 8.6 |
| Viscosity (23° C.): | 3800 mPas |
| Particle size (LCS): | 51 nm |

### APPLICATION EXAMPLES

The examples below show the advantages of the blocked polyisocyanates according to the invention as compared with the prior art: although similar properties were obtained in terms of film properties, more environmentally compatible products were released in the case of the lacquer systems according to the invention.

Clear lacquers were produced with the following composition. Films were produced from the clear lacquers, dried for 10 minutes at room temperature and then stoved for 30 minutes at 130° C. The films obtained were assessed in applicational terms. The results are summarised in Table 1.

TABLE 1
(NCO:OH = 1.0)

| | Polyisocyanate from example no. | | | | | |
|---|---|---|---|---|---|---|
| | | 1 | 2 | 3 | 4 | 5 |
| Product (g) | | | | | | |
| Bayhydrol ® PT 241¹⁾ | 20.1 | 20.1 | 20.1 | 20.1 | — | — |
| Bayhydrol ® VP LS 2290 | 54.9 | 54.9 | 54.9 | 54.9 | — | — |
| Additol ® XW 395 a.s. | 1.2 | 1.3 | 1.2 | 1.2 | 1 | 1 |
| Surynol ® 104, 50% in NMP | 1.2 | 1.3 | 1.2 | 1.2 | 1 | 1 |
| Dist. water | | | 66.0 | 17.0 | — | — |
| Polyisocyanate | 168.0 | 168.0 | — | — | 150.0 | 150.0 |
| Properties | | | | | | |
| Pendulum hardness (s) | 115 | 121 | 120 | 117 | 108 | 109 |
| Incipient solubility (1 min.) | 3344 | 3244 | 3244 | 3344 | 3444 | 4444 |
| Impact test | 20/40 | 40/40 | 20/40 | <20/40 | — | — |
| Cross-cut adhesion | 0 | 0 | 0 | 0 | 0 | 0 |

¹⁾Bayer AG, Leverkusen
a.s.: as supplied

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous preparations comprising blocked polyisocyanates according to formula (I) 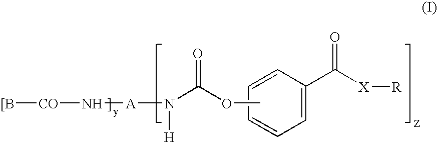
wherein
A denotes a radical of a polyisocyanate
B denotes a radical of a cationic, anionic and/or non-ionic hydrophilising agent,
X denotes oxygen, NH or NR,
R denotes hydrogen, C₁ to C₈ alkyl or cycloalkyl
Z stands for the number 1 to 8 and
Y denotes a number from 0.1 to 4.0, the equivalent ratio of z to y being from 20:1 to 1:1.

2. Preparations according to claim 1 comprising polyisocyanates blocked with a 2-hydroxybenzoic acid ester and/or a 4-hydroxybenzoic acid ester.

3. Preparations according to claim 1 comprising polyisocyanates blocked with an ethyl, propyl and/or methyl ester of 4-hydroxybenzoic acid.

4. Preparations according to claim 1 comprising blocked isocyanates prepared by reacting
a) 100% equivalent % polyisocyanate
b) 40-90 equivalent % hydroxybenzoic acid (derivative)
c) 10-40 equivalent % of a hydrophilising agent and optionally
d) 0-40 equivalent % of a preferably difunctional compound containing hydroxyl and/or amino groups and having an average molecular weight of 62 to 3000
wherein the proportions of the reaction components' are chosen such that the equivalent ratio of NCO groups in component a) to isocyanate-reactive groups in component b), c) and d) is from 1:0.8 to 1:1.2.

5. A process for the production of preparations according to claim 1, comprising reacting polyisocyanates with hydroxycarboxylic acids or derivatives thereof according to formula II 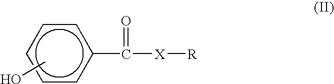
wherein
X denotes oxygen, NH or NR,
R denotes hydrogen, a C, to C₈ alkyl or cycloalkyl radical,
optionally in the presence of catalysts and/or cosolvents, optionally in water-miscible or in water-immiscible solvents, and
dissolving or dispersing the mixtures thus obtained in water or diluted with water-miscible solvents to form water-miscible solutions.

6. A method of preparing lacquers, paints and other coating materials, adhesives or elastomers comprising combining the preparations according to claim 1 with one or more materials selected from the group consisting of polyols, pigments, fillers, flow control agents, defoaming agents, catalysts and combinations thereof.

7. Stoving systems prepared according to the method of claim 6.

8. The method according to claim 6, wherein the preparations according to claim 1 are self-crosslinking systems.

9. A method of coating a substrate comprising applying the stoving system according to claim 7 to a surface of the substrate, wherein the substrate is selected from the group consisting of wood, metals, textiles, mineral substances and plastics and composites.

10. A process for coating substrates, comprising applying coating formulations comprising the aqueous preparations according to claim 1 to a substrate and then heating the substrate to a temperature at which the p-hydroxybenzoic acid ester is eliminated and the isocyanate groups are thereby released to react with the crosslinking agent to form a crosslinked polyurethane.

11. Preparations according to claim 2 comprising polyisocyanates blocked with an ethyl, propyl and/or methyl ester of 4-hydroxybenzoic acid.

12. Preparations according to claim 4 further comprising additives and auxiliary substances selected from the group consisting of pigments, fillers, flow control agents, defoaming agents, catalysts, and combinations thereof.
